(19) United States
(12) Patent Application Publication
(10) Pub. No.: US 2002/0010613 A1
(43) Pub. Date: Jan. 24, 2002

(54) Managed automobile repair and preventive maintenance system

(76) Inventor: Jeffrey Todd Di Lallo, San Diego, CA (US)

Correspondence Address: Jeffrey Todd Di Lallo, 2964 Juniper Street, San Diego, CA, 92104, US

(21) Appl. No.: 09/877,508

(22) Filed: Jun. 8, 2001

Related U.S. Application Data
(60) Provisional application No. 60/210,783, filed on Jun. 12, 2000.

(51) Int. Cl. G06F 17/60

(52) U.S. Cl. 705/8; 705/1

(57) ABSTRACT

This invention relates to a system and method for organizing, funding, managing, and providing automobile repair and preventive maintenance services for and among a voluntarily enrolled motor vehicle population within a specific geographic area More particularly, the present invention relates to a system and method for purchasing and providing automobile repair and maintenance services according to a prescribed program of managed care and service through a staff-model network of automobile repair and maintenance providers in the same manner that healthcare services are provided to human subscribers within a staff-model paradigm of managed human healthcare provider. By application of the business principles of managed care (including, but not limited to, the concepts of utilization review, closed panel care providers, case management, and pre-approval of procedures) costs to the subscriber will be reduced and unnecessary repairs and procedures eliminated.

### CROSS-REFERENCE TO RELATED APPLICATION

### U.S. Patent Documents

5774870 June, 1998 Storey

5794210 August, 1998 Goldhaber, et al.

5193056 March, 1993 Boes

20010002464 May 2001 Hogan

20010002468 May 2001 Nel

20010001144 May, 2,001 Kapp

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The present invention relates to a comprehensive system for the organization, funding, provision, and management of automobile repair and preventive maintenance services akin to the staff model paradigm utilized for more than three decades by the healthcare industry in the United States and abroad. More particularly, the present invention relates to a system and method for purchasing and providing automobile repair and maintenance services according to a prescribed program of managed care and service through a staff-model network of automobile repair and maintenance providers.

Historically, the procurement of automobile service and maintenance has involved a battle of wits between the providers of automobile repair and maintenance services (be these service personnel affiliated with an established automobile sales franchise, automobile technicians in the employ of established chain stores which provide such services, or the local mechanic at the nearest garage) and against the consumer. In the marketplace, the consumer has very often been at the mercy of the service provider who well knows that the average consumer is by and large ignorant as to the intricacies of the mechanical workings of their automobile(s). All too often unscrupulous service providers are in the position to dictate, exaggerate and inflate (often falsely or incorrectly) the extent and the cost of the repairs and/or maintenance which are required to return the consumer's automobile to a properly operational condition; said chicanery for the purpose of maximizing the financial gain of the service provider. These techniques have been reported on, highlighted, and videotaped by countless news organizations and consumer groups both locally and nationally. As a result, few consumers enjoy bringing their automobile in for repair or service and even fewer automobile owners relish receiving the bill associated with this undertaking. Consequently many consumers continue to operate their automobiles in a state of neglect or disrepair and thus create significant safety, efficiency, and environmental concerns.

This state of affairs is not accidental. It is the direct result of an uninformed and largely ignorant public left (until now) with no alternatives but to lay themselves at the mercy of a small number of well trained and savvy “entrepreneurs” who are all too willing to exploit their respective positions. Some consumers have sought to protect themselves against unknown and/or unexpectedly large automobile repair and maintenance costs through the purchase of long-term service contracts, extended warranties, or maintenance agreements; however, as was found to be the case within the healthcare industry, this arrangement merely transfers the costs associated with overbilling and the provision of unnecessary repairs from the consumer to the provider of the indemnity insurance policy. Ultimately, these costs are then passed on to those who purchase indemnity insurance policies of this kind.

Although the concept of managed care as a cost-saving system and a method by the elimination of unnecessary services and procedures has gained widespread acceptance by the public in the provision of healthcare services, it has not yet been applied in the field of automobile repair and maintenance. As it has in the healthcare industry, application of the principles of managed care to the provision of automobile repair and maintenance services will lead to the elimination of unnecessary procedures for automobile maintenance and repair, the reduction of costs to consumers enrolled in such a program (through the elimination of said unnecessary procedures, increases in the useful life expectancies of automobiles enrolled in the plan, and the gains in efficiencies of function of a vehicle which is in good condition and which is operating properly), greater consumer confidence in the mechanics, technicians and facilities (which the consumer will individually select from within the program to provide said services), and overall increases in the safety, efficiency and longevity of automobiles which benefit from routine and preventive maintenance and service as prescribed by such a plan.

The innovations provided by the present invention have the potential to turn what has historically been an uneasy and hostile standoff between consumers and the providers of automobile repair and maintenance services into an alliance based on mutual respect and mutual benefits. Society at large will benefit greatly from the widespread implementation of this concept.

### BRIEF SUMMARY OF THE INVENTION

Briefly, the present invention provides for the organization, funding, and provision of automobile repair and maintenance services so as to deliver optimum efficiency in the delivery of automobile repair and maintenance services at the lowest possible cost to the consumer within the parameters of a staff-model managed care environment.

This automobile repair and maintenance management system is also advantageous in that it provides to the owner of an enrolled automobile a monthly subscriber dues structure specific to each prospective vehicle model enrolled in the program thus providing the consumer with an exact annual cost for the maintenance and repair of that automobile enrolled in the plan.

Another advantage of the subject invention is that it provides a system for tracking and monitoring the repair and maintenance records and requirements of each specific automobile enrolled.

An additional advantage of the present invention is that it encourages the consumer to properly maintain the enrolled vehicle in accordance with manufacturer's specifications. This will lead to an improvement in the safety of the operation of the vehicle, an increase in the efficiency of operation of the vehicle, and an increase in the useful life expectancy of the enrolled automobile.

The present invention is further advantageous in that it provides an on-line, internet accessible method for viewing the services available through the program, a means of locating auto care facilities owned and operated by the managed auto care provider which offer the auto repair and maintenance services provided by the plan. Additionally, general information about the proper maintenance and service regimen of a given automobile safety and proper care tips about the operation an automobile, the status of the consumer's account with respect to their vehicle enrolled in the programs and a method for electronic enrollment in the plan are available at the website of the managed auto care provider. Lastly, the present invention will restore consumer confidence in and with the automobile repair and maintenance service industry by eliminating the incentive of automobile maintenance and repair providers to overstate the extent and complexity of required repairs or maintenance or to falsely inflate the cost of needed maintenance and repairs by providing to consumers who enroll their automobile(s) into the plan a simplified structure of annually fixed monthly dues in combination with a fixed co-payment fee plan and by fostering a long-term relationship between the consumer and a specific individual employed by the managed auto care provider and selected by the consumer from a closed panel who will function as a primary care technician and gatekeeper for the approval or denial of all maintenance and repair services rendered.

### BRIEF DESCRIPTION OF THE SEVERAL VIEWS OF THE DRAWING

Not Applicable

### DETAILED DESCRIPTION OF THE INVENTION

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated device, and such further applications of the principles of the invention illustrated herein, as would normally occur to persons skilled in the art to which the invention relates.

For the purposes of this specification, the terms “managed auto care provider”, “managed care provider”, “provider”, and “care provider” shall be used interchangeably and shall be taken to describe and to include the automobile repair and maintenance program concept further described herein which is operated within and/or functions upon the same business concepts and principles and in an identical manner, system, and method to a staff-model managed care provider of healthcare services.

The program according to the present invention is a system and method for organizing, funding, and managing the repair and maintenance costs associated with the ownership, lease, and operation of any automobile presently for sale or which has been sold in the United States within the past twenty (20) years through a network of auto care service facilities within a specific geographic region. As such, the invention is not an insurance policy, extended warranty, long-term service contract, or maintenance policy, but is, instead, the first-time combination of attributes from each of these different types of programs with the principles of managed healthcare as such principles have been applied in the staff-model provision of healthcare services in the United States for over three decades. Through the application of the principles of the staff-model managed healthcare provider, this invention utilizes and implements the concepts of monthly subscriber dues, a fixed co-payment level to be paid at the time that maintenance and/or repair services are rendered, the rendering of said services at a facility (or facilities) owned and/or operated by the managed auto care provider, agreement by the subscriber to the terms and conditions of (a disclosure statement and evidence of coverage document, a procedure and requirement for selection of a primary care technician from a closed panel of service technicians, the institution of gatekeepers or case managers who will provide or deny pre-approval for all maintenance and/or repair services, and the implementation of the principles of utilization review as these principles are applied for the purpose of determining what does or does not constitute necessary repairs or maintenance services.

To begin, a consumer may visit the online homepage of the automobile managed care provider. At such homepage, information will be provided to the prospective applicant with respect to an overall view of the program of managed automobile repair and maintenance services, links to additional pages within the website for acquisition of annualized subscriber dues and co-payment costs, the address(es) of facilities through which repair and maintenance services may be provided or additional information and literature with respect to the entity and the program procured, telephone and facsimile numbers for the entity, and an e-mail address through which the consumer can request additional details and/or information with respect to the entity and the program described herein.

Alternatively, a prospective applicant or customer may simply visit any of the existing facility (or facilities) owned and operated by the automobile managed care provider to pick up complimentary literature containing the same information (as described above) provided at the website of the automobile managed care provider.

Any consumer, owner, or lease-holder of a newly manufactured automobile who wishes to subscribe said automobile into the managed auto care provider program may enroll said automobile into the program within ninety (90) days of the acquisition of said automobile via one of three alternative methods.

The first method for enrollment into the program by the consumer who owns, leases, or operates a newly manufactured automobile may be commenced by contacting (via telephonic means) a customer service representative hired and salaried by the automobile managed care provider. Application information for subscription into the program of managed automobile repair and maintenance will be taken by said customer service representative and entered into an integrated on-line application form and database network installed on a central computer or computer server. The consumer applicant will be required to provide name, address, telephone, facsimile (if any), e-mail (if any) information, and data with respect to the exact make, model, year, mileage, and vehicle identification number (VIN) of the vehicle which is the subject of the application for enrollment into the program.

The integrated on-line database network has been programmed to issue a quotation for the requisite copayment fees associated with the prospective subject vehicle and the annual monthly subscriber dues which will be charged to the consumer upon their acceptance of the dues quotations, the disclosure statement, and the evidence of coverage documentation. Further, the integrated database network provides for the production of a “hard copy” of the applicant's dues quotation which can be mailed to the applicant, or, alternatively, said quotation can be faxed or e-mailed remotely from the workstation of the customer service representative utilizing the capabilities of the integrated database network.

The integrated online database network includes the capability for determining and generating a date (or dates) and an automatic reminder system designed to encourage and track customer service follow-up with prospective subscribers into the program of managed automobile repair and maintenance.

Upon acceptance by the applicant for subscription of a newly manufactured automobile of the evidence of coverage documentation and the disclosure statement and upon the payment by said applicant (via credit card, debit card, check, cash or money order) of one month's dues, said vehicle of said applicant shall become enrolled into the program of managed automobile repair and maintenance.

The second method of enrollment of a newly manufactured automobile by an applicant who wishes to subscribe to the program of managed automobile repair and maintenance any automobile as above described may be commenced and completed through the utilization of the on-line application form found at the website of the automobile managed care provider. As described above, this on-line application form will require the submission of information with respect to the applicant's name, address, telephone and facsimile numbers, the applicant's e-mail address (if any), and data with respect to the make, model year, current mileage and VIN of the vehicle which is the subject of the application. The integrated, on-line database network will then automatically generate for the applicant cost information with respect to co-payment and annual monthly dues fees and will provide for viewing and acceptance the evidence of coverage documentation and disclosure statement. Upon acceptance by the applicant of the fees, the disclosure statement and the evidence of coverage, the applicant may then complete enrollment of the subject vehicle into the program of managed automobile repair and maintenance by paying (on-tine) one month's subscriber dues via credit or debit card, or via automatic electronic debit from an established checking account in the name of the applicant.

The third alternative method of enrollment of a newly manufactured automobile into the program of managed automobile repair and maintenance may be commenced by an applicant who owns, leases, or operates an automobile as above described by the completion of a physical application form which may be obtained either through the mail delivery system or at a facility owned and operated by the managed automobile repair and maintenance provider. This physical application form must be completed to include the applicant's name, address, telephone and facsimile numbers, e-mail address (if any), the make, model year current mileage and VIN of the vehicle which is the subject of the application being made. A customer service representative salaried and employed by the managed care provider of automobile repair and maintenance services will then input the information supplied in the application form into the integrated database network. The integrated database network will then automatically generate cost information for the subject vehicle with respect to co-payment fees and annual monthly dues fees. The customer service representative will then convey this quotation to the applicant either personally, via telephonic or other electronic transmission methods, or by correspondence forwarded through the mail delivery system. Upon acceptance by the applicant of these fees, the applicants agreement to the disclosure statement and the evidence of coverage documentation, and the payment (either via credit or debit card, check, money order, cash, or automatic electronic debit from the applicant's checking account), the subject vehicle will be accepted into the program of managed automobile repair and maintenance.

Owners, operators, or lessees of any newly manufactured automobile for which enrollment into the programmed of managed automobile repair and maintenance is sought at a date which is more than ninety days from the date of purchase, or for applicants who are owners, operators or lessees of any automobile which is not newly manufactured or which is previously owned or leased may apply for enrollment into the program by way of two separate methods.

The first method of enrollment into the program of managed automobile repair and maintenance of a subject automobile which is not new, for which enrollment is sought at a date later than ninety days after the date of original purchase or which is previously leased, owned, or operated may be undertaken by contacting via telephonic means a customer service representative hired and employed by the automobile managed care provider. Said customer service representative will request information about the applicant and the subject vehicle, including the applicant's full name, mailing address, telephone and facsimile numbers, e-mail address (if any), the year, make, model year, current mileage and VIN of the automobile for which application into the program is sought. The customer service representative will enter all of this information into the integrated network database. The integrated, on-line network database then generates an automatic prompt to schedule a preapproval inspection of the subject vehicle and will not generate a co-payment or annual monthly dues quotation until such time as the subject vehicle has completed the pre-approval inspection at a facility owned and operated by the managed automobile repair and maintenance provider. At such time as the pre-approval inspection has been completed, pre-existing conditions noted, said pre-existing conditions excluded from coverage within the program and the applicant of the subject vehicle informed of these exclusions, the on-line, integrated database network will generate the requisite co-payment data and the annual monthly dues fees. Upon acceptance of the applicant of these fees and the exclusions, his or her acceptance of the disclosure statement and the evidence of coverage documentation, and the payment of (at least) one month's dues (either by cash, check, credit or debit card, or automatic electronic debit from the applicant's checking account), the subject vehicle will be accepted into the program of managed automobile repair and maintenance.

The second method by which an automobile which is not newly manufactured, which is previously owned, operated or leased, or for which enrollment into the program of managed automobile repair and maintenance is sought at a date which is more than ninety days after the purchase of said newly manufactured automobile may become enrolled into the program is via application over the telephone or through other electronic communications medium. Consumers who wish to subscribe via this method an automobile as hereinabove described will be required to provide to a customer service representative hired and employed by the managed automobile care provider information with respect to their name, mailing and e-mail addresses, telephone and facsimile numbers, and data with respect to the make, model year, current mileage, and VIN of the vehicle for which application is being made and enrollment into the program sought. The customer service representative will transcribe this information into the integrated network database at which time the integrated network database will generate an automatic prompt to schedule a preapproval inspection of the automobile which is the subject of the application The on-line, integrated network database will not generate co-payment or annual monthly dues data until such time as the subject vehicle has completed a pre-approval inspection, pre-existing mechanical conditions have been noted into the system and excluded from coverage under the program of managed automobile repair and maintenance, and the applicant is informed of and agrees to these exclusions. Contingent upon these events, the on-line, integrated database network will then generate the co-payment and annual monthly dues data for the subject vehicle. Upon the applicant's acceptance of these fees and exclusions, applicant's agreement with the disclosure statement and the evidence of coverage documents, and upon the payment of (at least) one month's dues (via credit or debit card, check, cash, or automatic electronic debit from an established checking account) the subject vehicle will become enrolled into the program of managed automobile repair and maintenance

Once accepted into the program, the owner, operator, or lessee of the subject vehicle will select a primary care technician from a closed panel of care technicians hired and salaried by the managed automobile care provider. In this capacity, the primary care technician will serve and provide the same functions assigned to a primary care physician within a managed healthcare environment. These functions include the prosecution of all necessary repair and maintenance work to the extent possible on the vehicles for which he/she has been selected to be the primary care technician and the rote of gatekeeper for a subscribed vehicle in which role the primary care technician may grant or deny pre-approval for any and all maintenance and repair procedures.

To obtain and/or utilize preventive maintenance and repair services, the subject vehicle will obtain said services from the selected primary care technician after the payment of the co-payment fee and only at a care facility which is owned and operated by the managed automobile care provider within the service area of the plan except in the case of a mechanical emergency and assuming that all monthly fees to the provider in the account of the subject vehicle are up-to-date. This system is exactly like that which is utilized in the staff-model paradigm established and utilized by the managed healthcare industry and further differentiates this system of automobile repair and maintenance from existing long-term service contracts, extended warranties and mechanical breakdown insurance programs

Also differentiating this invention from existing insurance and warranty programs is the inclusion within the scope of the provision of services of all routine maintenance needs in combination with the provision of all repair requirements. Furthermore, the managed care program of automobile repair and maintenance as herein described includes provision for the repair and replacement of “wear and tear” components of the enrolled vehicle. This benefit is for the lifetime of a subject vehicle and, as such, is not available within the scope of any existing long-term service contract or extended warranty nor within the scope of any extended maintenance contract presently offered in the marketplace. Out-of-area coverage for emergency service that cannot be reasonably attended to within the service area of the network of care facilities will be covered by the plan contingent upon the pre-approval of the primary care technician or technical director of the plan and at a payment rate to be determined by the primary care technician or technical director of the plan. Once again, this method of controlling costs and expenses is exactly like that system developed and utilized within the managed healthcare industry.

The principles of utilization review as these concepts are applied for the purpose of determining what does or does not constitute a necessary procedure or procedures, service and/or repair will be applied in determining the provision of emergency and all other repair service.

What I claim as my invention is:

1. A method for the reduction of overall consumer costs for the expenses associated with the maintenance and repair of an automobile or automobiles within a specific geographic region.

2. The first-time application of the business principles and methods of the staff-model managed healthcare organization to the automobile repair and maintenance industry, which principle, concepts and methods include but are not limited to:
a. the selection of a primary care provider;
b. the rendering of services at facilities owned and operated by the managed care organization within a prescribed geographic service plan;
c. the institution of a co-payment structure associated with the provision of services;
d. the creation and implementation of a monthly subscriber fee;
e. the introduction of the concept of the primary care provider functioning as a gatekeeper for the purpose of approving or denying any and all procedures or expenditures, and;
f. the application of the principles of utilization review as a means and method for the containment of costs.
